(19) United States
(12) Patent Application Publication
(10) Pub. No.: US 2005/0031018 A1
(43) Pub. Date: Feb. 10, 2005

(54) Zero-padded OFDM with improved performance over multipath channels

(75) Inventors: Panayiotis D. Papadimitriou, Euless, TX (US); Costas N. Georghiades, College Station, TX (US)

Correspondence Address: HARRINGTON & SMITH, LLP, 4 RESEARCH DRIVE, SHELTON, CT, 06484-6212, US

(73) Assignee: Nokia Corporation

(21) Appl. No.: 10/878,296

(22) Filed: Jun. 28, 2004

Related U.S. Application Data
(60) Provisional application No. 60/483,590, filed on Jun. 27, 2003.

(51) Int. Cl. H04B 1/707

(52) U.S. Cl. 375/141; 375/260

(57) ABSTRACT

Transmission of data from a base station to a set of users is improved by implementing an OFDM system as a CDMA system in which complex spreading codes are applied to the individual data in the transmitter and the receiver is a CDMA receiver.

### CLAIM OF PRIORITY FROM A COPENDING U.S. PROVISIONAL PATENT APPLICATION

This patent application claims priority under 35 U.S.C. 119(e) from Provisional Patent Application No. 60/483,590, filed Jun. 27, 2003, the content of which is incorporated by reference herein in its entirety.

### TECHNICAL FIELD

The field of the invention is wireless transmission of data, in particular telecommunication systems in which a base station transmits to one or more users.

### BACKGROUND OF THE INVENTION

In modern telecommunications, a bit sequence is sent by modulating a signal according to constellation points, onto either a single carrier wave (in the case of CDMA) to assume discrete values of a signal parameter or to a set of subcarriers in the case of orthogonal frequency division multiplexing (OFDM).

In order to reduce intersymbol interference, some systems add bits between symbols. FIG. 4 illustrates in simplified form a prior art OFDM system in which a set of users 1-M deliver a stream of bits to a base station that encodes each user's data using any convenient method in blocks 210-1 through 210-M and then modulates the encoded data with frequency-domain symbols (on a set of sub-carriers) from a constellation in blocks 230-1 through 230-M. The set of modulated symbols are then passed through an inverse Fourier transform in block 240 and have a cyclic prefix added in block 250. The composite signal including a set of subcarriers that cover the available spectrum is converted to RF and transmitted over antenna 255.

At the receiver, as shown in FIG. 5, there is only one bit stream of interest, so the receiver system removes the prefix in unit 550, performs the Fourier Transform in unit 540, equalizes and demodulates the frequency-domain multi-user symbols in unit 530, then decodes the stream of data in unit 510 and then extracts the data for that particular user in unit 505. These units are conventional, known in the art and may be implemented in general purpose computers or in special-purpose integrated circuits.

It has been proposed recently to replace the cyclic prefix (CP) in OFDM (Orthogonal Frequency Division Multiplex) transmission by zero-padding (ZP), which guarantees symbol recovery even when channel nulls are located on a subcarrier [1]. (Numbers in brackets [ ] refer to references listed at the end of the text.) This, though, has the disadvantage that the simple DFT-based receiver does not perform well [2], but results have shown that if much higher complexity turbo demodulation is used, ZP-OFDM outperforms CP-OFDM.

### SUMMARY OF THE INVENTION

The invention relates to a method of transmitting data from a base station to multiple users using N-carrier OFDM implemented as multicode CDMA with complex spreading codes.

A feature of the invention is that a system can apply to ZP-OFDM the numerous suboptimum multi-user receivers developed for CDMA.

Since the performance of these receivers is dictated by the correlation properties of the IDFT matrix, another feature of the invention is that we “modify” the IDFT matrix used to modulate the data in ZP-OFDM so that the resulting matrix possesses better correlation properties, and hence improved performance over multipath channels can be achieved.

### BRIEF DESCRIPTION OF THE DRAWINGS

FIG. 1 shows a block diagram of a transmitter for use with the invention.

FIG. 2 shows a performance comparison with the invention and prior art CP-OFDM.

FIG. 3 shows a comparison with the invention and prior art CP-OFDM for a different transmission channel.

FIG. 4 shows a block diagram of a prior art transmitter.

FIG. 5 shows a block diagram of a prior art receiver.

FIG. 6 shows an example of a receiver for use with the invention.

### DESCRIPTION OF AN EMBODIMENT OF THE INVENTION

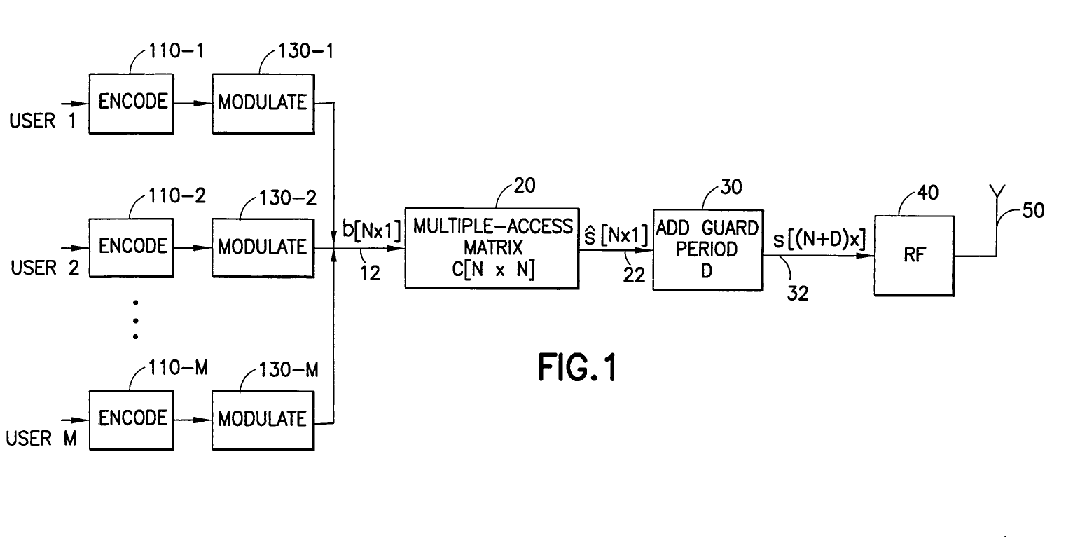

The system to be considered (transmitter side) is depicted in FIG. 1.

On the left, blocks 110-1-110-M and 130-1 and 130-M represent manipulation of the incoming bit streams of one or more users in a base station. The output of this stage is the vector b on line 12. Vector b has N dimensions since one or more users may have more than one code. Thus, N in general will not be equal to M. The N-dimensional multi-user symbol vector b is multiplied in unit 20 with the transpose of the multiple-access matrix C, where for OFDM C is the IDFT matrix with elements C[α,β] ≡W_{N}^{αβ}≡e^{i2παβ/N}, α,β=0,1, . . . ,N−1 to form the vector \tilde{S} on line 22, where

$$\tilde{s} = \frac{1}{\sqrt{N}} {C}^{T} b , \qquad ( 1 )$$

with (·)^{T} denoting the transpose of a matrix, and the normalization factor 1/\sqrt{N} is needed so that each symbol of b is transmitted with unit energy. Finally, prior to transmission, a guard period of length D is added in unit 30 to the transmitted symbol \tilde{s}, on line 32. This vector is converted to RF and transmitted from the antenna.

In this work, we view ZP-OFDM as multicode CDMA with complex spreading sequences, each one of which is assigned to a single user and no intersymbol interference, assuming long enough zero-padding. The spreading sequences are provided by the elements of C=e^{i2παβ/N} as defined above.

The matrix to encode the user symbols (IDFT matrix in this case) should possess good auto- and cross-correlation properties, since the performance of the aforementioned receivers over multipath channels is dictated to a large extent by the correlation properties of this matrix. Unfortunately, the IDFT matrix does not possess good correlation properties, so we propose to modify the matrix such that the resulting matrix possesses better correlation properties. We show also through simulation that the better correlation properties of the modified matrix compared to the IDFT matrix translate to a significant gain in performance over multipath channels, at the expense of course in receiver complexity.

A system according to the invention therefore uses receivers from the well-studied CDMA multiuser detection research area (e.g. PIC, LMMSE [4]).

According to one embodiment of the invention, the spreading codes are complex numbers that are determined by the elements of matrix C, as shown above. Each code (i.e. each matrix row) is assigned to a single user.

For the CP-OFDM the guard period is a cyclic prefix, i.e.

$$S = [ \begin{matrix}{\tilde{s}}_{[ N - D : N - 1 ]} \\ \tilde{s}\end{matrix} ] , \qquad ( 2 )$$

where \tilde{s}_{[N-D:N-1]} simply denotes the last D elements of the vector \tilde{s}, and for the ZP-OFDM in the prior art the guard period is simply zero-padding, i.e.

$$s = [ \begin{matrix}\tilde{s} \\ {0}_{D}\end{matrix} ] , \qquad ( 3 )$$
where 0_{D} is an all-zero vector of length D. We will refer to the elements of vector s as chips.

In a matrix form, we can write
s=Λb, (4)
where

$$Λ = \{ \begin{matrix}\frac{1}{\sqrt{N}} [ \begin{matrix}{[ {C}^{T} ]}_{[ N - D : N - 1 , : ]} \\ {C}^{T}\end{matrix} ] , & for CP - OFDM ; \\ \frac{1}{\sqrt{N}} [ \begin{matrix}{C}^{T} \\ {0}_{D \times N}\end{matrix} ] , & for ZP - OFDM .\end{matrix} \qquad ( 5 )$$

where [C^{T}]_{[N-D:N-1,:]} denotes the matrix comprising the last D rows of C^{T}, and O_{D×N} is an all-zero matrix of dimensions D×N.

The transmitted signal s is subject to multipath block fading and additive white Gaussian noise at the receiver front-end. Let h₁1=0,1, . . . ,L, be the channel impulse response in each J=N+D length block, where h₁=0,∀l∉[0,L] and L is the channel memory. We assume L≦D. The received signal can then be written as
y=HΛb+n (6)
where H is the J×J convolution matrix with elements H[i,j]=hᵢ₋ⱼ, and n=[n₀, n₁, . . . , n_{J}]^{T} the noise vector, with nⱼ i.i.d., zero-mean, circularly symmetric complex Gaussian random variables having variance N₀.

At the receiver, we employ a receiver having a simple DFT for the CP-OFDM [5], and a partial-PIC (parallel interference canceller), [6,7,8], as well as a Bayesian linear minimum mean square error (LMMSE) estimator [9] for ZP-OFDM. The receiver accepts the incoming signal on the antenna and converts the RF to baseband. Separate data streams for individual users may be divided by any convenient method, well known to those skilled in the art, such as time division.

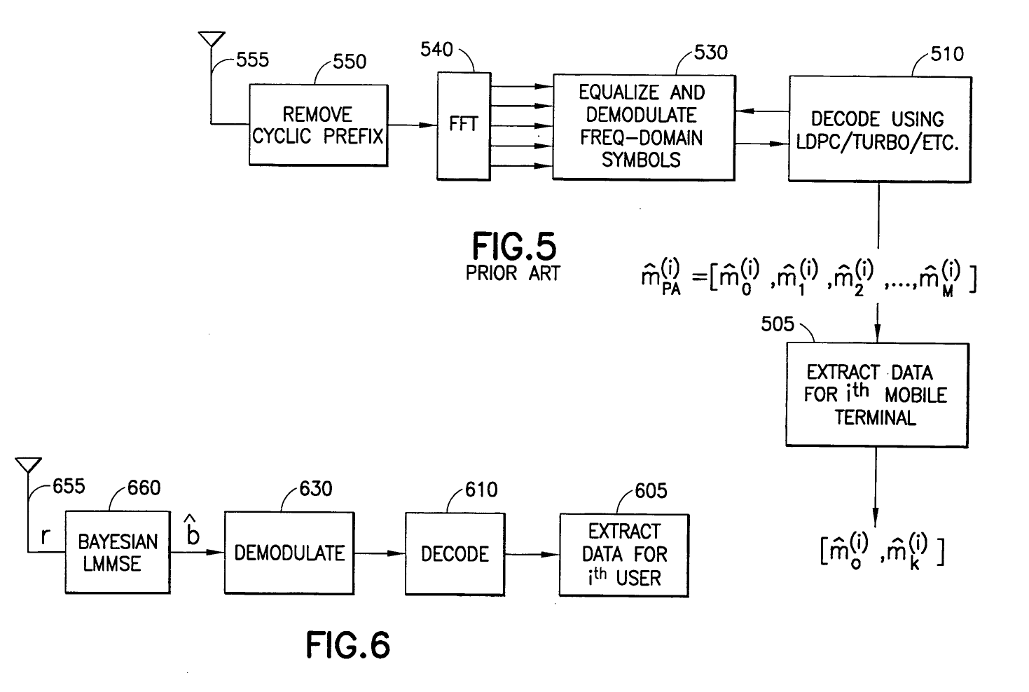

At FIG. 6 illustrates a block diagram of a receiver for use with the invention. The RF signals are received on antenna 655 and pass into a CDMA receiver such as a Bayseian LMMSE receiver. This receiver, operating in accordance with CDMA practice, generates a vector b that is further processed. The next block 620 demodulates the data from the carrier and passes it to block 610 that performs the decoding operation. Since there is typically only one user at a receiver, the data for that user are extracted from the composite data stream in block 605.

It is well known that CP-OFDM with a DFT receiver turns the multipath channel into a flat fading channel for which equalization is trivial; in the example illustrated here, we use simple zero-forcing (ZF) [5]. Those skilled in the art will adopt the disclosure to their own needs and the invention is not limited to ZF.

On the other hand, it can be shown that the performance of the partial-PIC or Bayesian LMMSE receiver depends on the correlation properties of the rows of the multiple-access matrix C, (see e.g. [9], [7,4]).

Next we will address the correlation properties of the IDFT matrix and provide a “modified” version of it possessing improved correlation properties.

The aperiodic crosscorrelation function [10] will be used to evaluate the multiple-access matrix' correlation properties.

For a pair of complex sequences x=[x₀, x₁, . . . ,x_{N-1}] and y=[y₀,y₁, . . . ,y_{N-1}] of length N (i.e. a pair of rows of the multiple-access matrix C), the aperiodic cross-correlation (CC) function is defined as

$${C}_{xy} ( l ) = \{ \frac{1}{N} {\sum }_{k = 0}^{N - 1 - l} {x}_{k} {y}_{k + 1}^{*} , 0 \leq l \leq N - 1 ; \frac{1}{N} {\sum }_{k = 0}^{N - 1 + l} {x}_{k - 1} {y}_{k}^{*} , 1 - N \leq l < 0 ; 0 , \vert l \vert \geq N \qquad ( 7 )$$

where ( )* denotes the complex conjugate.

Moreover, to evaluate the correlation properties of the multiple-access matrix (i.e. the set of all its N rows of length N), we use the average mean square value of the CC, R_{cc} which is defined as [11],

$$\begin{matrix}{R}_{CC} = \frac{1}{N ( N - 1 )} {\sum }_{x = 1}^{N} {{\sum }_{y = 1}^{N}}_{y \neq x} {\sum }_{l = 1 - N}^{N - 1} {\vert {C}_{xy} ( l ) \vert}^{2} , \\ where & ( 8 ) \\ {C}_{xy} ( l ) {\vert}_{x = i , y = j} & ( 9 )\end{matrix}$$

is the aperiodic crosscorrelation at lag l between the rows i and j (counting starts from one) of the matrix C

Similarly for the autocorrelation we have [11],

$${R}_{AC} = \frac{1}{N} {\sum }_{x = 1}^{N} {{\sum }_{l = 1 - N}^{N - 1}}_{l \neq 0} {\vert {C}_{xx} ( l ) \vert}^{2} . \qquad ( 10 )$$

The correlation properties of the IDFT matrix (N=64) are summarized in Table 1, where besides R_{cc} and R_{AC}, the absolute peaks (“abs Pk”) of the cross-correlation and auto-correlation are also given.

TABLE I
correlation properties

| | | | | CC | AC |
|---|---|---|---|---|---|
| Matrix | N | RCC | RAC | (abs pk) | (abs pk) |
| IDFT | 64 | 0.169 | 20.836 | 0.318 | 0.984 |
| IDFT-M | 64 | 0.497 | 0.170 | 0.234 | 0.141 |

Since, as mentioned previously, a system according to the invention achieves the results of OFDM by using multicode CDMA with complex spreading codes from the N-PSK alphabet, we may improve the correlation properties of the IDFT matrix, similarly to the improvement of the Hadamard matrix' correlation properties in CDMA systems. That is we will multiply each column of the IDFT matrix with a bit of an “m-sequence”, e.g. the m-sequence resulting from the primitive polynomial 103₈ (in octal) [12]. Since, however, this m-sequence is of length 63, we will place a 0, (−1) at the front to make it of length N=64.

So, if C_{IDFT} is the IDFT matrix, and v the vector resulting from the m-sequence by appending to it a zero bit, the resulting matrix, denoted IDFT-M, is given by the following:
C_{IDFT-M}=C_{IDFT}V (11)
where V is a diagonal matrix, with v in its diagonal. The correlation properties of the IDFT-M matrix, are given also in Table 1.

Another method of improving the correlation properties of the matrix is to randomly permute the columns. This does not change the property of orthogonality. This method will be referred to as IFDT-R.

In operation, the process of modifying the C matrix may be carried out as often as desired, with appropriate communication with the receivers when a change is made; i.e. if the random choice is made only at the start of a transmission, the information on the vector V may be transmitted in a setup sequence, while if the vector is changed more frequently, a conventional data channel or reserved space in the stream of data may be used.

It is clear that the IDFT-M matrix possesses better correlation properties than the IDFT matrix, except for a small increase in the R_{cc} value. Note that the IDFT-M matrix is still unitary, since the multiplication by ±1 of the IDFT unitary matrix columns doesn't destroy the matrix unitarity.

We evaluate the performance of the ZP-OFDM with the modified IDFT matrix (IDFT-M), compared to the conventional CP-OFDM, and ZP-OFDM (which use the IDFT) through simulations over multipath Rayleigh block fading channels (channel remains constant over a transmitted block of length N+D). In addition, perfect channel state information at the receiver is assumed.

For an evaluation, the chip period is set to T_{C}=50 ns as in Hiperlan/2 Wireless Local Area Network (WLAN) [13] and N=64, D=16 Furthermore, the symbols of the vector b (see FIG. 1) are QPSK-modulated.

We assume two different channel models with delay spreads much smaller than N=64 (and also smaller than the guard period D). The first is given in Table 2 with delay spread equal to 4 chip periods, and the second channel model is the Hiperlan/2 (HL2) Channel A [14] (with block fading) which has delay spread approximately equal to 8 chip periods (³⁹⁰ ns).

TABLE II
5-PATH MULTIPATH CHANNEL

| Tap | Delay | Power |
|---|---|---|
| 1 | 0 | 0.75 |
| 2 | T_{C} | 0.20 |
| 3 | 2T_{C} | 0.02 |
| 4 | 3T_{C} | 0.02 |
| 5 | 4T_{C} | 0.01 |

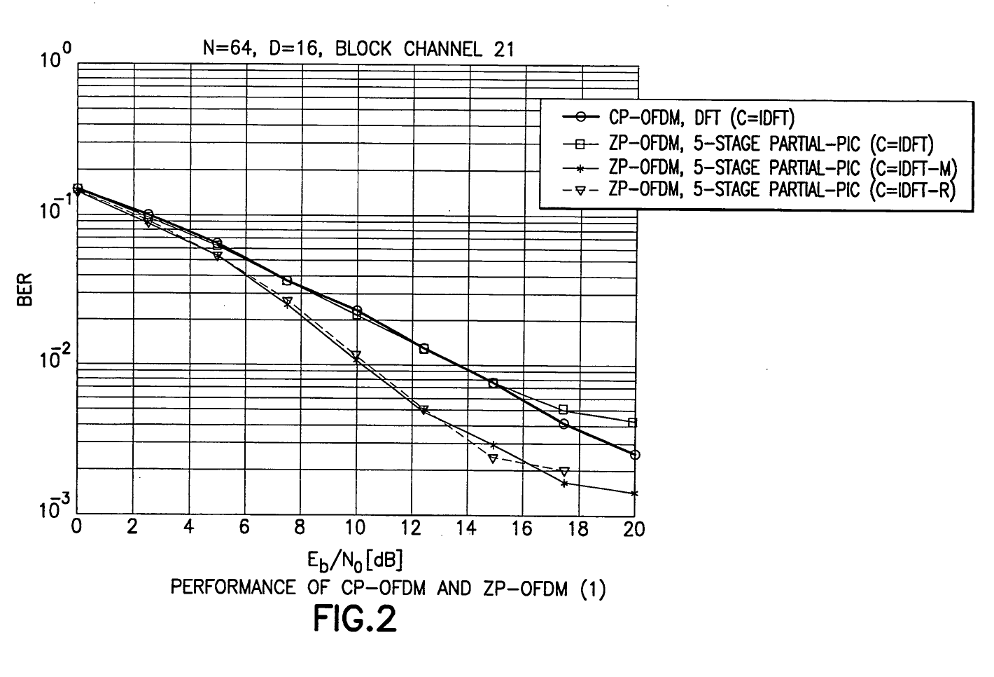

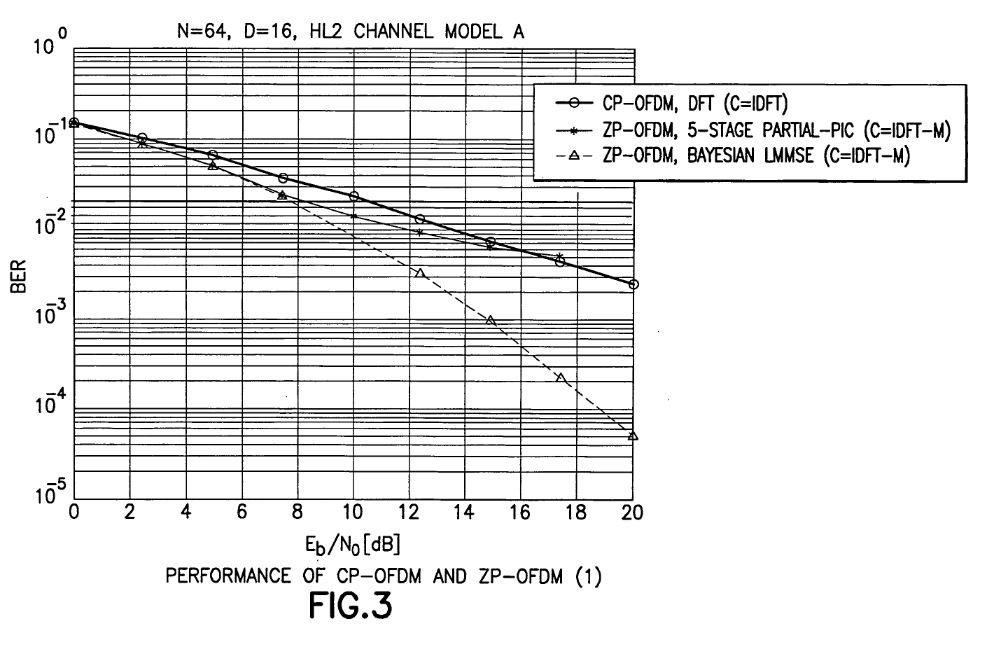

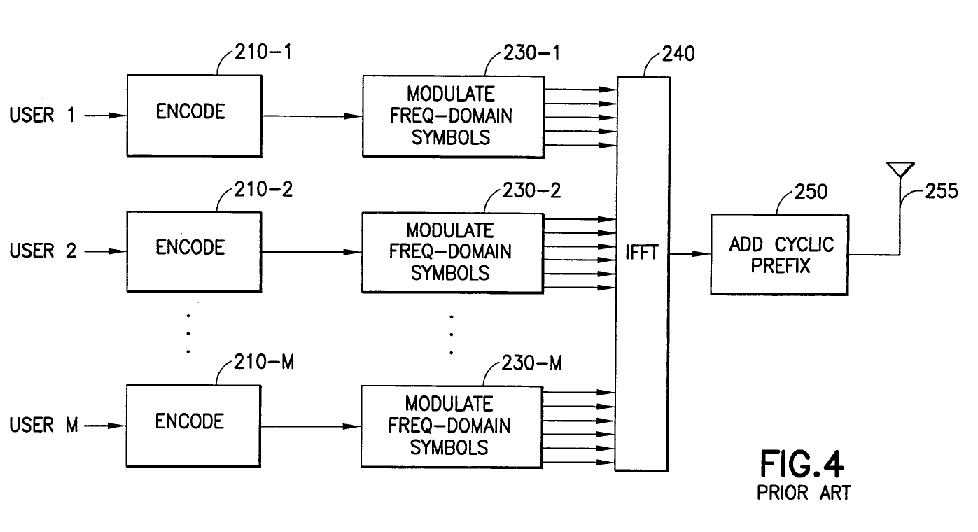

The performance results (bit error rate (BER)) are shown in FIGS. 2 and 3. We first observe, from the slope of the curves, that CP-OFDM achieves only diversity one [15,16].

The first curve shown in FIG. 2 is a prior art CP-OFDM with a DFT receiver. The ZP-OFDM with the Bayesian LMMSE receiver outperforms by about 1 dB at high E_{b}/N₀ CP-OFDM with ZF (zero-forcing) receiver. On the other hand, we see that ZP-OFDM with an IDFT-M matrix according to the invention dramatically outperforms CP-OFDM as well as ZP-OFDM (with IDFT), at least with the Bayesian LMMSE receiver.

Therefore the modified IDFT matrix (IDFT-M), possessing better correlation properties than the IDFT, significantly improved the performance of the conventional ZP-OFDM.

In the case of the prior art ZP-OFDM with IDFT though, we see that there is practically no gain obtained by moving from the 5-path channel to Channel A.

From the foregoing, those skilled in the art will appreciated that a wireless transmission from a base station to a set of users may be effected by transmitting according to the methods described above.

A further benefit of the invention is that an OFDM transmission may be performed with CDMA hardware by using complex spreading codes and then using a conventional CDMA receiver in the mobile terminals used by the users. The complex spreading codes are the located in the rows of the multiple access matrix, i.e. IDFT, IFDT-M, etc.

In operation, the sequence of steps for a transmission in a prior art OFDM system is:
Receive a stream of data from at least one user;
2. encode the data;
3. modulate the encoded symbols (box 230 in FIG. 5);
4. multiply the output vector by the IDFT matrix;
5. add the padding;
6. convert from baseband to RF and transmit.

At the receiver:
1. Receive the composite RF signal;
2. convert to baseband;
3. remove the prefix;
4. multiply by the DFT matrix;
5. equalize. and demodulate
6. decode;
7. extract user data.

According to the invention, the transmission sequence is:
Receive a stream of data from at least one user;
   2. encode the data;
   3. modulate the encoded symbols (box 230 in FIG. 5);
   4. multiply the output vector by the IDFT-M or IDFT-R matrix;
   5. add zero padding;
   6. convert from baseband to RF and transmit.

At the receiver:
1. Receive the composite RF signal;
2. convert to baseband;
3. apply a CDMA receiver, e.g. Baleysian LMMSE;
4. demodulate;
5. decode;
6. extract user data.

Thus, we see that the performance of conventional CP-OFDM and ZP-OFDM can be improved by using instead ZP-OFDM with a modified IDFT matrix. The modification was based on a classical method used on CDMA systems, where after the spreading (multiplication) of the multiuser symbol vector with the Hadamard-Walsh matrix, the resulting chips are further scrambled by the pseudo-random long code (which is also called quadrature spreading, see e.g. [17]).

The coded performance comparison of the systems considered in this paper, is also of high interest. For the sake of simplicity, the performance results of FIGS. 2 and 3 are uncoded. We expect that further gains will be obtained by employing turbo-like receivers [3].

### REFERENCES

[1] B. Muquet, Z. Wang, G. B. Giannakis, M. de Courville, and P. Duhamel, “Cyclic prefixing or zero padding for wireless multicarrier transmissions?” IEEE Trans. Com., vol. 50, no. 12, pp. 2136-2148, December 2002.
[2] E. F. Casas and C. Leung, “OFDM for data communication over mobile radio FM channels—Part I: Analysis and experimental results,” IEEE Trans. Com., vol.39, no. 5, pp. 783-793, May 1991.
[3] B. Muquet, M. de Courville, P. Duhamel, G. B. Giannakis, and P. Magniez, “Turbo demodulation of zero-padded OFDM transmissions,” IEEE Trans. Com., vol. 50, no. 11, pp. 1725-1728, Nov. 2002.
[4] S. Verdu, Multiuser Detection Cambridge University Press, 1998.
[5] A. Pandharipande, “Principles of OFDM,” IEEE Potentials, vol. 21, no. 2, pp. 16-19, Apr.-May 2002.
[6] M. K. Varanasi and B. Aazhang, “Multistage detection in asynchronous code-division multiple-access communications,” IEEE Trans. Com., vol. 38, pp. 509-519, April 1990.
[7] D. Divsalar, M. K. Simon, and D. Raphaeli, “Improved parallel interference cancellation for CDMA,” IEEE Trans. Com., vol. 46, pp. 258-268, Feb. 1998.
[8] W. Tantiphaiboontana, “CDM: Code division multiplexing and its applications,” Ph.D. dissertation, Texas A&M University, May 2003.
[9] S. M. Kay, Fundamentals of Statistical Signal Processing—Vol. I Estimation Theory Prentice Hall, 1993.
[10] D. V. Sarwate and M. B. Pursley, “Crosscorrelation properties of pseudorandom and related sequences,” Proc. of the IEEE, vol. 68, no. 5, pp. 593-619, May 1980.
[11] I. Oppermann and B. S. Vucetic, “Complex spreading sequences with a wide range of correlation properties,” IEEE Trans. Com., vol. 45, no. 3, pp. 365-375, March 1997.
[12] R. L. Peterson, R. E. Ziemer, and D. E. Borth, Introduction to Spread Spectrum Communications Prentice-Hall, 1995.
[13] A. Doufexi, S. Armour, M. Butler, A. Nix, D. Bull, and J. McGeehan, “A comparison of the HIPERLAN/2 and IEEE 802.11a wireless LAN standards,” IEEE Com. Mag., pp. 172-180, May 2002.
[14] J. Medbo and P. Schramm, “Channel models for HIPERLAN/2 in different indoor scenarios,” ETSI EP BRAN 3ERI085B, March 1998.
[15] D. L. Goeckel and G. Ananthaswamy, “Increasing diversity with non-standard signal sets in wireless OFDM systems,” in IEEE Wireless Com. and Networking Conf. (WCNC), 1999.
[16] Z. Wang, X. Ma, and G. B. Giannakis, “Optimality of single-carrier zero-padded block transmissions,” in IEEE Wireless Com. and Networking Conf. (WCNC), 2002.
[17] “Physical layer standard for cdma2000 spread spectrum systems,” 3GPP2 C.S0002-C, v. 1.0, May 2002.
[18] B. J. Wysocki and T. A. Wysocki, “Optimization of orthogonal polyphase spreading sequences for wireless data applications,” in IEEE Vehicular Tech. Conf (VTC), October 2001.

1. A method of transmitting data from at least one user comprising the steps of:
receiving at least one stream of data from said at least one user;
encoding said stream of data with a set of complex codes and forming a symbol vector;
multiplying said symbol vector by a multiple-access matrix to produce an intermediate vector;
adding a zero-padding prefix to said intermediate vector from an output vector;
converting said output vector to an RF output and transmitting said RF output as a transmitted signal.

2. A method according to claim 1, in which said multiple access matrix is formed by permuting the columns of an IDFT matrix.

3. A method according to claim 1, in which said multiple access matrix is formed by multiplying each column of an IDFT matrix by a bit from a pseudo-random sequence.

4. A method according to claim 1, in which said multiple access matrix is formed by multiplying each column of an IDFT matrix by a bit from an m-sequence.

5. A method according to claim 1, in which said multiple access matrix is formed by permuting the columns of a Hadamard matrix.

6. A method according to claim 1, in which said multiple access matrix is formed by multiplying each column of a Hadamard matrix by a bit from a pseudo-random sequence.

7. A method according to claim 1, in which said multiple access matrix is formed by multiplying each column of a Hadamard matrix by a bit from an m-sequence.

8. A method according to claim 1, further comprising a step of receiving said transmitted signal in a CDMA receiver.

9. A method according to claim 11, in which said CDMA receiver is an LMMSE receiver.

10. A method according to claim 11, in which said CDMA receiver is a partial PIC receiver.

11. A system for transmitting data from a base station to a set of users comprising a base station having data processing means for receiving a set of data streams from at least one user, encoding said set of data streams with a corresponding set of complex codes, multiplying said data streams by a multiple access matrix, adding a zero-padding guard period, converting to RF signals and transmitting, said RF signals;
at least one user receiver having RF means for receiving said RF signals; and
selecting a data stream for said at least one user.

12. A system according to claim 11, in which said multiple access matrix is an IDFT matrix having at least one column randomly permuted.

13. A system according to claim 11, in which each column of said multiple access matrix is multiplied by a bit from a preudo-random sequence.

14. A system according to claim 11, in which said multiple access matrix is formed by multiplying each column of an IDFT matrix by a bit from an m-sequence.

15. A system according to claim 11, in which said multiple access matrix is formed by multiplying each column of a Hadamard matrix by a bit from a pseudo-random sequence.

16. A system according to claim 15, in which said multiple access matrix is formed by multiplying each column of a Hadamard matrix by a bit from an m-sequence.
